(19) United States
(12) Patent Application Publication
(10) Pub. No.: US 2025/0187372 A1
(43) Pub. Date: Jun. 12, 2025

(54) LINEAR ACTUATOR

(71) Applicant: VDX INNOVATION CO., LTD., Jinan (CN)

(72) Inventor: Koenraad REYBROUCK, Etterbeek (BE)

(21) Appl. No.: 19/060,768

(22) Filed: Feb. 23, 2025

Related U.S. Application Data
(63) Continuation of application No. PCT/IB2023/058352, filed on Aug. 22, 2023.

(30) Foreign Application Priority Data
Aug. 22, 2022 (NL) 2032814

(51) Int. Cl. B60B 35/10

(52) U.S. Cl. CPC B60B 35/1045; B60B 35/1081

(57) ABSTRACT

An actuator for a wheel suspension for a vehicle includes a housing, an electric motor, a piston rod and a fluid exchange means. The housing includes a housing wall. The electric motor is configured for rotating the screw around its axis causing a screw nut to linearly move along a screw. The piston rod assembly is slidably coupled to the housing. The piston rod assembly includes a piston arranged at a predetermined distance from the housing wall such that a first cavity is formed between the piston and the housing wall. The piston rod assembly delimits a second cavity configured to house the screw assembly. The screw nut is coupled to the piston rod assembly such that the linear movement of the screw nut causes the piston rod assembly to be moved between a retracted position and an extended position.

### CROSS-REFERENCE TO RELATED APPLICATIONS

The present application is a continuation application of International Application No. PCT/IB2023/058352, filed on Aug. 22, 2023, which claims priority to Netherlands Patent Application No. 2032814, filed on Aug. 22, 2022, the entire contents of which are hereby incorporated by reference.

### TECHNICAL FIELD

The present disclosure relates to an actuator for a wheel suspension for a vehicle. The disclosure relates particularly to an actuator for wheel suspension having at least a variable track width which is adjustable between a narrow track and a wide track.

### BACKGROUND

WO2016058060 A1 describes a wheel suspension comprising a frame suitable for connection to a body of a vehicle and comprising a first and second wheel which together define a track width. The first wheel is connected to the frame via a first set of actuators and the second wheel is connected to the frame via a second set of actuators such that by means of operating the actuators the track width is adjustable between a narrow track, wherein the first set of actuators overlaps in the transverse direction of the vehicle with the second set of actuators.

In practice some of the actuators will be subjected to side forces because the actuators can be fixed at various locations to for example either the frame, a knuckle, a suspension arm, or a further actuator, in such a way that the actuators a substantially horizontally orientated. The side forces are angled with respect to the movement direction of the actuators, hence their denomination.

The actuator comprises a housing having a housing wall, an electric motor mechanically coupled to a screw assembly having a screw and an associated screw nut; wherein the electric motor is configured for rotating the screw around its axis causing the screw nut to linearly move along the axis of the screw. The actuator comprises a piston rod assembly slidably coupled to the housing, wherein the piston rod assembly comprises a piston rod arranged at a predetermined distance from the housing wall such that a first cavity is formed between the piston rod and the housing wall, and wherein the piston rod assembly delimits a second cavity configured to house the screw assembly. The screw nut is coupled to the piston rod assembly such that the linear movement of the screw nut causes the piston rod assembly to be moved between a retracted position and an extended position, wherein in the extended position the piston rod assembly protrudes substantially outward from the housing. To increase longevity and provide optimal performance, particularly because the side forces cause substantial wear if the actuator is incorrectly maintained, the first cavity and the second cavity are provided with a fluid comprising at least a gaseous phase and a liquid phase.

Various approaches have been evaluated but none provide a robust and operationally reliable way of lubricating the actuators. Lubricating the actuator using nipples is such an approach but requires a substantial amount of maintenance and is operationally less reliable, particularly because such an approach requires maintenance at regular intervals. External lubrication systems are not robust and a breakdown thereof substantially reduces longevity of the actuators. Also, external lubrication systems are expensive and complex to implement in a wheel suspension having variable track width. CN111288135 and EP2491273 describe actuators having a means for lubrication.

### SUMMARY

It is an object of the disclosure to propose an actuator having a robust and operationally reliable way of lubricating itself in a selfsustained manner.

The disclosure provides for this purpose an actuator characterized by having a fluid exchange means configured to exchange at least part of the fluid between the first cavity and second cavity based on the movement of the piston.

The advantage hereof is based on the insight that the combination of rotational movement and linear movement of the actuator, for example by moving from the retracted to the extended position to turn a vehicle, changes the respective volumes of the first cavity and the second cavity. The volume of the first cavity is proportional to the position of the piston rod assembly in the housing. The volume of the first cavity is also proportional to a difference of an outside surface area of the piston rod assembly with respect to an inner surface area of the housing wall, i.e. the sides of the piston rod assembly and the housing wall delimiting the first cavity. Particularly, the volume of the first cavity when the piston rod assembly is situated in the retracted position is larger than the volume of the first cavity when the piston rod assembly is in the extended position. This difference in volume of the first cavity in the retracted position and the extended position, particularly, a reduction of volume when moving from the retracted to the extended position, pressurizes the fluid in the first cavity. Meanwhile, the volume of the second cavity proportionally and inversely changes with respect to the volume of the first cavity. The volume of the second cavity thus enlarges when the piston rod assembly moves from the retracted position to the extended position. The enlarging volume of the second cavity reduces the pressure of the fluid in the second cavity. In this way a differential pressure is created between the first cavity and the second cavity when the piston rod assembly is moved. The differential pressure causes the fluid to be moved from the cavity having the higher pressure to the cavity having the lower pressure. It will be apparent that moving from the extended to the retracted position enlarges the volume of the first cavity, respectively reduces the volume of the second cavity and the above-mentioned differential pressure is inverse causing the fluid to flow from the second cavity to the first cavity. The differential pressure caused by moving the piston rod assembly during operation thus provides an easy, robust and selfsustained way of reliably lubricating the actuator.

Preferably, the fluid exchange means comprises a first fluid channel and a second fluid channel formed in the piston and which respectively fluidly connect the first cavity and the second cavity. The first and second fluid channel allow the fluid to flow from the first cavity to the second cavity and vice versa in a relatively simple manner. More preferably, the first and second fluid channel comprise a cross-sectional area of at least 0.5 mm², preferably at least 10 mm². The inventors have found that the first and second fluid channel comprising a cross-sectional area of at least 0.5 mm² provides a balanced differential pressure and flow rate between the first and second cavity. More preferably, the first fluid channel and the second fluid channel are an aperture through the piston wall. Such an aperture is robust, easily manufacturable and in a situation where maintenance of the actuator is required easily cleanable.

Preferably, the fluid exchange means further comprises a first shut-off means and a second shut-off means correspondingly arranged such that the first shut-off means allows fluid to flow from the first cavity to the second cavity through the first fluid channel and inhibits flow from the second cavity to the first cavity and such that the second shut-off member only allows fluid to flow from the second cavity to the first cavity through the second channel. In this way a circular flow of the fluid is created inside the actuator. The circular flow is advantageous because the fluid is forced in a direction reducing stagnation of the fluid in certain locations, this improves lubrication of the actuator.

Preferably, the first fluid channel and corresponding first shut-off means are arranged at an upper segment of the piston wall, preferably an uppermost segment, and wherein the second fluid channel and corresponding first shut-off means are arranged at a lower segment of the piston wall, preferably a lowest segment. An advantageous hereof is based on the insight that the actuators arranged in a wheel suspension having variable trackwidth are typically oriented in a substantially horizontal way. By providing the first fluid channel and corresponding first shut-off means and the second fluid channel and corresponding second shut-off means in an uppermost segment and a lower segment the circular flow comprises an upward and downward component in that the movement of the actuator to the extended position forces the fluid upward, through the first fluid channel into the second channel. Similarly, when moving from the extended position to the retracted position, the fluid is forced downward from the second cavity, through the second fluid channel into the first cavity.

Preferably, the first shut-off means covers the first fluid channel and is arranged on a side of the piston wall delimiting the second cavity and where the second shut-off means covers the second fluid channel and is arranged on a side of the piston wall delimiting the first cavity. Preferably, the first shut-off means and the second shut-off means are made from a resilient material. In this way, the fluid can open the fluid channels when pressure is exerted from one side of the shut-off means. The resiliency of the shut-off means allows the shut-off means to open the fluid channel by bending in a direction away from the exerted pressure. Additionally, the resiliency of the shut-off means also allows the shut-off means to shut the fluid channels when the direction of the pressure on the fluid is reversed, for example when the second cavity is pressurized with respect to the first cavity. More preferably, the resilient material is an elastomer.

Preferably, the piston rod has a proximal end and a distal end, wherein the fluid exchange means are arranged near the proximal end of the piston rod. In this way, the fluid exchange means are allowed maximum travel within the actuator and thus also circulate a maximum amount of fluid with respect to that actuator.

Preferably, the actuator further comprises a set of bearings arranged between the housing and the piston, wherein the set comprises a first bearing and a second bearing, wherein the first bearing is arranged at a proximal end of the piston, and wherein the second bearing is at a distal end of the piston, wherein the set of bearings is configured to slidably support the piston rod assembly in the housing.

Preferably, the actuator further comprises a seal arranged between the piston and the housing. Even though the first and second cavity are fluidly connected, the seal inhibits the fluid from flowing through other openings, such as the opening between the piston and the housing. This improves the lubrication of the actuator further.

Preferably, the actuator further comprises a further seal arranged between the electric motor and the second cavity, which further seal is configured to substantially prevent fluid from flowing from the second cavity to the electric motor. Although the fluid can be used to cool the electric motor, it is preferred that the fluid is retained in the first and second cavity.

Preferably, the actuator further comprises a first connection means and a second connection means respectively arranged at a proximal end and a distal end of the actuator such that the actuator is pivotably connectable any one of a vehicle frame, a suspension strut and a knuckle.

Preferably, the actuator further comprises a suspension strut support arranged at a distal end of the housing, which suspension struct support is configured to rigidly support a suspension support.

### BRIEF DESCRIPTION OF THE DRAWINGS

The accompanying drawings are used to illustrate presently preferred non-limiting exemplary embodiments of devices of the present disclosure. The above and other advantages of the features and objects of the disclosure will become more apparent, and the disclosure will be better understood from the following detailed description when read in conjunction with the accompanying drawings, in which:

FIG. 1 illustrates a perspective view of an actuator according to a preferred embodiment;

FIG. 2 illustrates a sectional view of the actuator as indicated in FIG. 1;

FIG. 3 illustrates an enlarged view of part of the actuator as indicated in FIG. 2.

### DESCRIPTION OF THE EMBODIMENTS

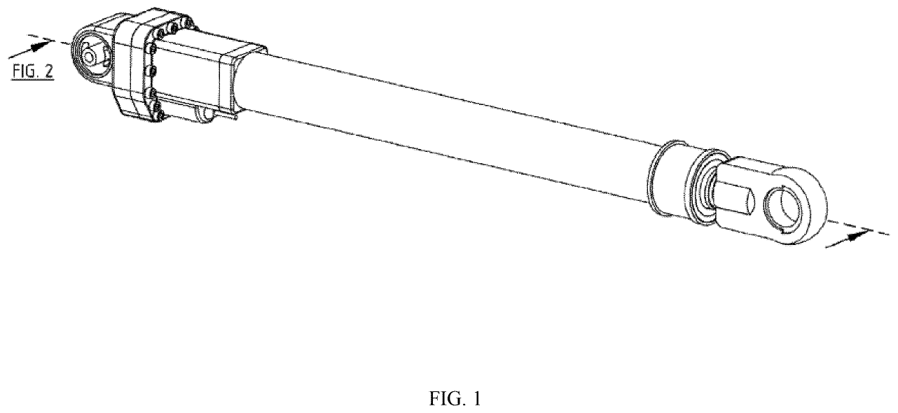

FIG. 1 illustrates a perspective view of an actuator 100 for a wheel suspension for a vehicle according to a preferred embodiment. The actuator 100 is preferably for use with wheel suspension having at least a variable track width which is adjustable between a narrow track and a wide track. Vehicles with variable track widths can have three or more wheels. In a configuration with three wheels a single wheel will be placed at the front or rear while two wheels are then provided at a distance from each other at respectively the rear or front (the distance being in the transverse direction of the vehicle). These two wheels define a track width. The greater the track width, the wider the vehicle and the more stable the road holding. The greater the track width however, the more space the vehicle will take up. The narrower the track width, the narrower the vehicle and the less stable the road holding. The narrower the track width however, the less space the vehicle will take up. It will be apparent that other factors can also influence the stability of a vehicle. The actuator 100 can further be applied to vehicles with four wheels, for example a transport van or passenger bus. Most commercial vehicles have four wheels. The foremost two of the four wheels are typically steerable here such that the direction of travel can be determined and the vehicle can be steered. Despite the fact that the actuator is designed particularly for commercial vehicles with three or four wheels, it will be apparent that the actuator can likewise be applied to special purpose vehicles which are designed for a specific reason and can therefore have a specific number of wheels other than three or four wheels. On the basis of this description the skilled person will however be able to apply the actuator in vehicles of other configuration.

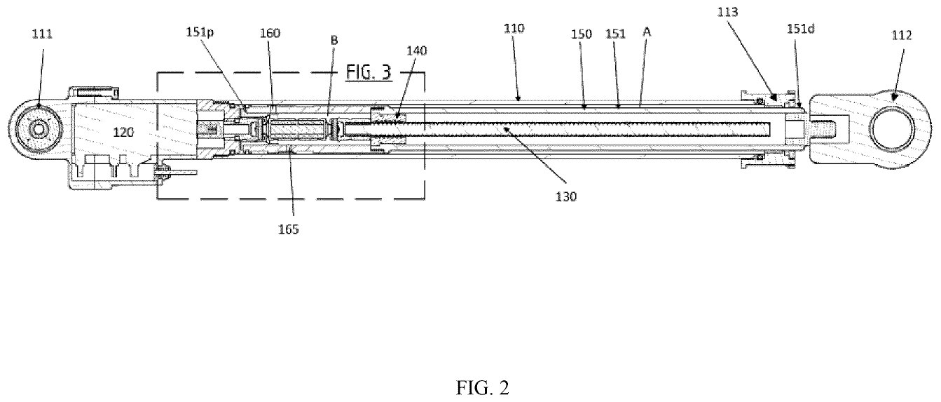

FIG. 2 illustrates a sectional view of the actuator as indicated in FIG. 1. The actuator 100 has a proximal end P and a distal end D. FIG. 2 shows in particular that the actuator 100 comprises a housing 110. The housing 110 comprises a housing wall 111. Near the proximal end P the actuator 100 may comprise a first connection means 112. Near the distal end D the actuator may comprise a second connection means 113. In this way the actuator 100 can be pivotably connectable to any one of a vehicle frame, a suspension strut and a knuckle. Moreover, in order to rigidly support a suspension support, a suspension strut support 114 may be arranged near any one of the proximal and the distal end.

The actuator 100 further comprises an electric motor 120. The electric motor 120 is preferably arranged near the proximal end P of the actuator 100. The electric motor 120 is mechanically coupled to a screw assembly. The screw assembly has a screw 130 and an associated screw nut 140. The screw 130 is preferably a cylindrical shaft with a thread provided on its outer wall. The associated screw nut 140 comprises a through hole through which the screw passes. On an inside of the through-hole a thread or other guidance is provided which corresponds to the thread of the screw 130. When the electric motor 120 rotates the mechanical coupling rotates the screw 130 around its axis, causing the screw nut 140 to linearly move along the axis of the screw. In other words, the screw converts a rotational motion of the electric motor 120 to a linear motion of the screw nut 140.

The actuator 100 further comprises a piston rod assembly 150 slidably coupled to the housing 110. The piston rod assembly 150 comprises a piston rod tube 151 arranged at a predetermined distance from the housing wall 111. The predetermined distance I measured radially from the centre of the actuator 100. Because the piston rod tube 151 is arranged at a distance from the housing wall 111 a first cavity A is formed between the piston rod tube and the housing wall. From FIG. 1 it can be seen that the actuator wall 110 is at least partially cylindrical. It is preferred that the piston rod assembly is also at least partially cylindrically shaped. The outside area of the piston wall is in this case smaller than an inner area of the actuator wall 111, thus creating the first cavity A. Moreover, the piston rod assembly 150 is hollow and delimits a second cavity B in which the screw assembly is housed. The screw nut 140 is coupled to the piston rod assembly 150 such that the linear movement of the screw nut causes the piston rod assembly 150 to be moved between a retracted position and an extended position. Put differently, the piston rod assembly 150 slides relative to the housing 110. In the extended position the piston rod assembly 150 protrudes substantially outward from the housing. FIGS. 1 and 2 illustrate the piston rod assembly 150 in the retracted position, in which the actuator housing wall 111 and the piston rod assembly 150 overlap each other substantially completely seen in the longitudinal direction of the actuator 100.

Moreover, the first cavity A and the second cavity B are provided with a fluid comprising at least a gaseous phase and a liquid phase. The liquid phase of the fluid can be a lubricating oil, whereas the gaseous phase can be dryed air or an inert gas such as nitrogen. The actuator 100 further comprises a fluid exchange means 160, 165 configured to exchange at least part of the fluid between the first cavity A and second cavity B based on the movement of the piston rod assembly 150. By moving the piston rod assembly 150 from the retracted to the extended position for example to turn a vehicle, changes the volumes of the first cavity A and the second cavity B relative to each other because the volume of the first cavity A is proportional to the position of the piston rod assembly 150 in the housing 110. Particularly, the volume of the first cavity A when the piston rod assembly is situated in the retracted position is larger than the volume of the first cavity A when the piston rod assembly is in the extended position. This difference in volume of the first cavity in the retracted position and the extended position, particularly, a reduction of volume when moving from the retracted to the extended position, pressurizes the fluid in the first cavity A. Meanwhile, the volume of the second cavity B proportionally and inversely changes with respect to the volume of the first cavity A because the volume of the second cavity B enlarges when the piston rod assembly 150 moves from the retracted position to the extended position. The enlarging volume of the second cavity B reduces the pressure of the fluid in the second cavity. In this way a differential pressure is created between the first cavity A and the second cavity B when the piston rod assembly 150 is moved. The differential pressure causes the fluid to be moved from the cavity having the higher pressure to the cavity having the lower pressure. It will be apparent that moving from the extended to the retracted position enlarges the volume of the first cavity A, respectively reduces the volume of the second cavity B and the above-mentioned differential pressure is inversed causing the fluid to flow from the second cavity B to the first cavity A. The differential pressure caused by moving the piston rod assembly 150 during operation thus provides an easy, robust and selfsustained way of reliably lubricating the actuator 100.

According to a further preferred embodiment the actuator 100 further comprises a set of bearings 181, 182 arranged between the housing 110 and the piston rod assembly 150. The set comprises a first bearing 181 and a second bearing 182, wherein the first bearing 181 is arranged near a proximal end 151p of the piston wall 151, and the second bearing 182 is arranged near a distal end 151d of the piston rod. This allows to slidably support the piston rod assembly 150 in the housing 110.

FIG. 2 further illustrates that the fluid exchange means 160, 165 comprises a first fluid channel 160 and a second fluid channel 165 formed in the piston rod tube 151. In the illustrated embodiment, the fluid exchange means 160, 165 are arranged near the proximal end 151p of the piston. In this way, piston rod assembly 150 is allowed maximum travel within the actuator 100 and thus also circulates a maximum amount of fluid with respect to that actuator.

The first fluid channel 160 and a second fluid channel 165 respectively fluidly connect the first cavity A and the second cavity B. The first and second fluid channel 160, 165 allow the fluid to flow from the first cavity A to the second cavity B and back in a relatively simple manner. The first fluid channel 160 and the second fluid channel 165 are preferably an aperture through the piston, as illustrated in FIG. 2. Such an aperture is robust, easily manufacturable and in a situation where maintenance of the actuator is required easily cleanable. The aperture, or put differently, through-hole extends entirely through the piston rod tube 151. In order to provide a balanced differential pressure and flow rate between the first and second cavity, the first and second fluid channel comprise a cross-sectional area of at least 0.5 mm², preferably at least 10 mm².

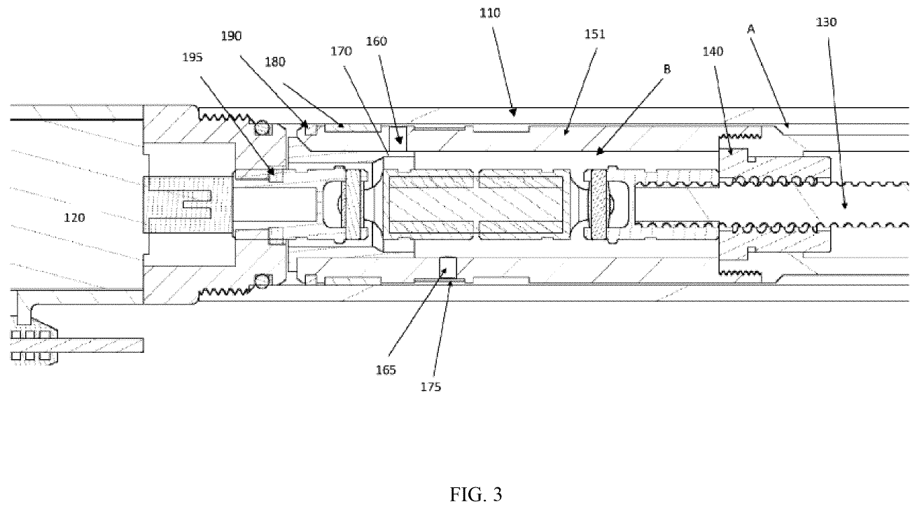

FIG. 3 illustrates an enlarged view of part of the actuator 100 as indicated in FIG. 2.

FIG. 3 illustrates that the circumferential area of the piston rod assembly 150 may change. For example, the portion of the piston rod assembly 150 housing, in the figure the portion is indicated with reference number 151, a coupling means 121 configured to mechanically couple the electric motor 120 to the screw assembly, and in particular to the screw 130 of the screw assembly, may have a larger circumferential area with respect to the portion of the cylinder which can slidably extend outside of the actuator 100. It is noted that any suitable coupling means 121 can be used.

The enlarged view of FIG. 3 illustrates that the fluid exchange means comprise a first fluid channel 160 and a second fluid channel 165 formed in the piston rod tube 151 and which respectively fluidly connect the first cavity A and the second cavity B.

The fluid exchange means further comprises a first shut-off means 170 and a second shut-off means 175 correspondingly arranged such that the first shut-off means 170 substantially exclusively allows fluid to flow from the first cavity A to the second cavity B through the first fluid channel and such that the second shut-off member 175 substantially exclusively allows fluid to flow from the second cavity B to the first cavity A through the second channel. Put differently, the first shut-off means 170 inhibits the fluid to flow from the second cavity B to the first cavity through the first fluid channel 160. The second shut-off means 175 inhibits the fluid to flow from the first cavity A to the second cavity B through the second fluid channel 165.

FIG. 3 illustrates that the first shut-off means 170 preferably covers the first fluid channel 160 and is arranged on a side of the piston rod tube 151 delimiting the second cavity B, i.e. the inner side of the piston rod assembly 150. The second shut-off means 175 preferably covers the second fluid channel 165 and is arranged on a side of the piston delimiting the first cavity A, i.e. an outside of the piston rod assembly 150. The first shut-off means 170 and the second shut-off means 175 are preferably made from a resilient material. In this way, the fluid can open the fluid channels 160, 165 when pressure is exerted from one side of the shut-off means 170, 175. For example, when the piston rod assembly is moved to the extended position, pressure rises in the first cavity A. The rising pressure allows the resilient first shut-off means 170 to be biased to an open position, in which the first shut-off means 170 no longer covers the first fluid channel 160, and allows fluid to pass from the first cavity to the second cavity B. The resiliency of the shut-off means 165 allows the shut-off means to open the first fluid channel 160 by bending in a direction away from the exerted pressure. Additionally, the resiliency of the shut-off means 170, 175 also allows the shutoff means to shut the fluid channels when the direction of the pressure on the fluid is reversed, for example when the second cavity B is pressurized with respect to the first cavity when the piston rod assembly 150 is moved to the retracted position. Preferably, the resilient material is an elastomer. It will be clear that the first and second shut-off means may also be arranged in the first and second fluid channel, respectively.

Preferably, the first fluid channel 160 and corresponding first shut-off means 170 are arranged at an upper segment of the piston, preferably an uppermost segment. The second fluid channel 165 and corresponding first shut-off means 175 are preferably arranged at a lower segment of the piston, preferably a lowest segment. An advantageous hereof is based on the insight that the actuator 100 arranged in a wheel suspension having variable trackwidth are typically oriented in a substantially horizontal way. By providing the first fluid channel 160 and corresponding first shutoff means 170 and the second fluid channel 165 and corresponding second shut-off means 175 in an uppermost segment and a lower segment the circular flow comprises an upward and downward component in that the movement of the actuator 100 to the extended position forces the fluid upward, through the first fluid channel into the second channel. Similarly, when moving from the extended position to the retracted position, the fluid is forced downward from the second cavity B, through the second fluid channel 165 into the first cavity A.

FIG. 3 further illustrates that the actuator 100 may further comprise a seal 190 arranged between the piston rod tube 151 and the housing 110 such that Even though the first cavity A and second cavity B are fluidly connected, the seal 190 inhibits the fluid from flowing through other openings, such as the opening between the piston rod tube 151 and the housing 110 near the proximal end of the piston rod assembly and housing. Moreover, the actuator may also comprise a further seal 195 arranged between the electric motor 120 and the second cavity B, which further seal is configured to substantially prevent fluid from flowing from the second cavity B to the electric motor.

The description and drawings merely illustrate the principles of the present disclosure. It will thus be appreciated that those skilled in the art will be able to devise various arrangements that, although not explicitly described or shown herein, embody the principles of the present disclosure and are included within its scope. Furthermore, all examples recited herein are principally intended expressly to be only for pedagogical purposes to aid the reader in understanding the principles of the present disclosure and the concepts contributed by the inventor(s) to furthering the art, and are to be construed as being without limitation to such specifically recited examples and conditions. Moreover, all statements herein reciting principles, aspects, and embodiments of the present disclosure, as well as specific examples thereof, are intended to encompass equivalents thereof.

It should be noted that the above-mentioned embodiments illustrate rather than limit the present disclosure and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim. The word “a” or “an” preceding an element does not exclude the presence of a plurality of such elements. The present disclosure can be implemented by means of hardware comprising several distinct elements and by means of a suitably programmed computer. In claims enumerating several means, several of these means can be embodied by one and the same item of hardware. The usage of the words “first”, “second”, “third”, etc. does not indicate any ordering or priority. These words are to be interpreted as names used for convenience.

In the present disclosure, expressions such as “comprise”, “include”, “have”, “may comprise”, “may include”, or “may have” indicate existence of corresponding features but do not exclude existence of additional features.

Whilst the principles of the present disclosure have been set out above in connection with specific embodiments, it is to be understood that this description is merely made by way of example and not as a limitation of the scope of protection which is determined by the appended claims.

What is claimed is:

1. An actuator for a wheel suspension for a vehicle, comprising:
a housing comprising a housing wall;
an electric motor mechanically coupled to a screw assembly having a screw and an associated screw nut, wherein the electric motor is configured for rotating the screw around its axis causing the screw nut to linearly move along the axis of the screw;
a piston rod assembly slidably coupled to the housing, wherein the piston rod assembly comprises a piston arranged at a predetermined distance from the housing wall such that a first cavity is formed between the piston and the housing wall, and wherein the piston rod assembly delimits a second cavity configured to house the screw assembly, wherein the screw nut is coupled to the piston rod assembly such that the linear movement of the screw nut causes the piston rod assembly to be moved between a retracted position and an extended position, wherein in the extended position the piston rod assembly protrudes substantially outward from the housing; wherein the first cavity and the second cavity are provided with a fluid comprising at least a gaseous phase and a liquid phase;
a fluid exchange means configured to exchange at least part of the fluid between the first cavity and second cavity based on the movement of the piston, wherein the fluid exchange means comprises a first fluid channel and a second fluid channel formed in the piston and which respectively fluidly connect the first cavity and the second cavity.

2. The actuator according to claim 1, wherein the first and second fluid channel comprise a cross-sectional area of at least 0.5 mm², preferably at least 10 mm².

3. The actuator according to claim 1, wherein the first fluid channel and the second fluid channel are an aperture through the piston.

4. The actuator according to claim 1, wherein the fluid exchange means further comprises a first shut-off means and a second shut-off means correspondingly arranged such that the first shut-off means exclusively allows fluid to flow from the first cavity to the second cavity through the first fluid channel and such that the second shut-off member exclusively allows fluid to flow from the second cavity to the first cavity through the second channel.

5. The actuator according to claim 4, wherein the first shut-off means covers the first fluid channel and is arranged on a side of the piston delimiting the second cavity, and where the second shut-off means covers the second fluid channel and is arranged on a side of the piston delimiting the first cavity.

6. The actuator according to claim 4, wherein the first shutoff means and the second shut-off means are made from a resilient material.

7. The actuator according to claim 6, wherein the resilient material is an elastomer.

8. The actuator according to claim 1, wherein the piston has a proximal end and a distal end, wherein the fluid exchange means are arranged near the proximal end of the piston.

9. The actuator according to claim 1, further comprising a set of bearings arranged between the housing and the piston, wherein the set comprises a first bearing and a second bearing, wherein the first bearing is arranged at a proximal end of the piston, and wherein the second bearing is at a distal end of the piston, wherein the set of bearings is configured to slidably support the piston rod assembly in the housing.

10. The actuator according to claim 1, further comprising a seal arranged between the piston and the housing.

11. The actuator according to claim 1, comprising a further seal arranged between the electric motor and the second cavity, which further seal is configured to substantially prevent fluid from flowing from the second cavity to the electric motor.

12. The actuator according to claim 1, further comprising a first connection means and a second connection means respectively arranged at a proximal end and a distal end of the actuator such that the actuator is pivotably connectable any one of a vehicle frame, a suspension strut and a knuckle.

13. The actuator according to claim 1, further comprising a suspension strut support arranged at a distal end of the housing, which suspension struct support is configured to support a suspension support.
